(19) United States
(12) Patent Application Publication
(10) Pub. No.: US 2026/0112789 A1
(43) Pub. Date: Apr. 23, 2026

(54) METHOD FOR MANUFACTURING LEAD TAB FOR SECONDARY BATTERY AND LEAD TAB FOR SECONDARY BATTERY MANUFACTURED THEREBY

(71) Applicant: NSM CO., LTD., Cheongju-si (KR)

(72) Inventors: Taesung JUNG, Cheongju-si (KR); Yuncheol MOON, Cheongju-si (KR); Yanghun PARK, Cheongju-si (KR); Kwangseok CHOI, Cheongju-si (KR)

(21) Appl. No.: 19/009,403

(22) Filed: Jan. 3, 2025

(30) Foreign Application Priority Data
Oct. 17, 2024 (KR) 10-2024-0141882

(51) Int. Cl. H01M 50/536

(52) U.S. Cl. CPC H01M 50/536

(57) ABSTRACT

A method of manufacturing a lead tab for a secondary battery comprises the steps of: (a) providing heat of a predetermined temperature or higher to the lead tab having a processing pattern formed on each of top and bottom surfaces to form an oxide film on the surfaces on which the processing pattern is formed; and (c) coating the surfaces on which the processing pattern is formed by spraying an adhesive solution, wherein (b) a step of controlling a temperature of the lead tab is provided between steps (a) and (c) so that the adhesive solution may be coated on the surface of the lead tab in an optimized state at step (c).

### CROSS-REFERENCE TO RELATED APPLICATIONS

This application claims the priority of Korean Patent Application No. 10-2024-0141882 filed on Oct. 17, 2024, in the Korean Intellectual Property Office, the disclosure of which is incorporated herein by reference.

### BACKGROUND OF THE INVENTION

### Field of the Invention

The present invention relates to a method of manufacturing a lead tab for a secondary battery and a lead tab for a secondary battery manufactured according thereto.

### Background of the Related Art

Generally, secondary batteries are batteries that can be used repeatedly through a discharge process of converting chemical energy into electrical energy and a charge process of converting electrical energy into chemical energy. The secondary batteries may include nickel-cadmium (Ni—Cd) batteries, nickel-metal hydride (Ni-MH) batteries, lithium-metal batteries, lithium-ion (Li-Ion) batteries, lithium-ion polymer batteries, and the like.

Lithium secondary batteries among the secondary batteries may have characteristics optimized for mobile devices as they have a cycle life of about 500 times or more and a short charging time of about 1 to 2 hours, can be lightweighted as they are about 30 to 40% lighter than the nickel-metal hydride batteries, and have the highest voltage per unit cell (3.0 to 3.7 V) and excellent energy density among the existing secondary batteries.

The lithium secondary batteries like this may include an electrode assembly accommodated in a battery case, a lead tab electrically connected to electrodes provided in the electrode assembly and extended outside the battery case, and a sealant film (insulating film) that electrically insulates the lead tab.

In particular, the sealant film may perform a function of sealing the interface between the lead tab and the electrode case as one side is fused to the lead tab and the other side opposite to the one side is fused to the electrode case.

However, since the lead tab and the sealant film are made of different materials, there is a limit in firmly fusing them together. Therefore, the applicant of the present invention proposes a technique related to manufacturing a lead tab that can further improve the adhesiveness between the lead tab and the sealant film and maximize productivity by reducing occurrence of defects when manufacturing the lead tab.

(Patent Document 0001) Korean Patent Publication No. 10-1586072 (Registered on Jan. 11, 2016)

### SUMMARY OF THE INVENTION

Therefore, the present invention has been made in view of the above problems, and it is an object of the present invention to provide a method of manufacturing a lead tab for a secondary battery, which can prevent deterioration of product quality by increasing bonding strength with a sealant film without being corroded although it contacts the electrolyte of a secondary battery cell, and a lead tab for a secondary battery manufactured according thereto.

To accomplish the above object, according to one aspect of the present invention, there is provided a method of manufacturing a lead tab for a secondary battery, the method comprising the steps of: (a) providing heat of a predetermined temperature or higher to the lead tab having a processing pattern formed on each of top and bottom surfaces to form an oxide film on the surfaces on which the processing pattern is formed; and (c) coating the surfaces on which the oxide film is formed by spraying an adhesive solution, wherein (b) a step of controlling a temperature of the lead tab is provided between steps (a) and (c) so that the adhesive solution may be coated on the surface of the lead tab in an optimized state at step (c).

Step (b) may include a step of (b1) increasing the temperature of the lead tab to a second set temperature higher than a first set temperature.

Step (b) further may include, before step (b1), a step of (b0) decreasing the temperature of the lead tab increased through step (a) to the first set temperature.

Step (c) may be a step of coating the upper surface of the lead tab by spraying an adhesive solution, wherein the method may further comprise, after step (c), the step of (f) coating the bottom surface of the lead tab by spraying an adhesive solution, wherein the step of (e) controlling the temperature of the lead tab may be provided between steps (c) and (f) so that the adhesive solution is coated on the bottom surface of the lead tab in an optimized state at step (f).

The method of manufacturing a lead tab for a secondary battery may further comprise the steps of: (d1) drying and removing the adhesive solution remaining on the top surface of the lead tab, and (d2) reversing the lead tab up and down, between steps (c) and (e); and drying and removing the adhesive solution remaining on the bottom surface of the lead tab, after step (f).

Step (e) may include the steps of decreasing the temperature of the lead tab increased through step (a) to a first set temperature, and increasing the temperature of the lead tab to a second set temperature higher than the first set temperature after decreasing the temperature to the first set temperature; or the step of increasing the temperature of the lead tab to the second set temperature.

The step of decreasing the temperature of the lead tab to the first set temperature and the step of increasing the temperature of the lead tab to the second set temperature may include the step of arranging a temperature block having a set temperature formed therein to directly contact the surface on which the processing pattern is formed, or blowing a gas of the set temperature onto the surface on which the processing pattern is formed.

The step of drying and removing the adhesive solution remaining on the top surface and the bottom surface of the lead tab may include a step of drying by radiating an ultraviolet ray on the surface of the lead tab.

The method of manufacturing a lead tab for a secondary battery may further comprise the steps of: (g1) drying and removing the adhesive solution remaining on the surface of the lead tab after step (c); and (g3) coating the surface of the lead tab by additionally spraying an adhesive solution after step (g1), wherein the step of controlling the temperature of the lead tab is provided between steps (g1) and (g3) so that the adhesive solution is coated on the surface of the lead tab in an optimized state at step (g2).

Step (g2) may include: the steps of decreasing the temperature of the lead tab increased through step (a) to a first set temperature, and increasing the temperature of the lead tab to a second set temperature higher than the first set temperature after decreasing the temperature to the first set temperature; or the step of increasing the temperature of the lead tab to the second set temperature.

### BRIEF DESCRIPTION OF THE DRAWINGS

FIG. 1 is a flowchart sequentially showing a method of manufacturing a lead tab for a secondary battery according to a first embodiment of the present invention.

FIG. 2A is a plan view a showing a lead tab manufactured through a method of manufacturing a lead tab for a secondary battery according to a first embodiment of the present invention.

FIG. 2B is a cross-sectional view taken along IIB-IIB of FIG. 2A.

FIG. 3 is an SEM image showing a protrusion structure on the surface of a lead tab etched through laser radiation in a method of manufacturing a lead tab for a secondary battery according to a first embodiment of the present invention.

FIGS. 4A and 4B are a view comparing the states of adsorbing PVA adhesive as a lead tab after a PVA adhesive coating operation is performed with and without performing a lead tab optimization process before PVA adhesive coating.

FIG. 5 and FIG. 6 are flowcharts sequentially showing a method of manufacturing a lead tab for a secondary battery according to a second embodiment of the present invention.

### DETAILED DESCRIPTION OF THE PREFERRED EMBODIMENT

Hereinafter, embodiments of the present invention will be described in more detail with reference to the accompanying drawings. However, the present invention is not limited to the embodiments disclosed below, but may be implemented in various different forms, and these embodiments are provided only to make the disclosure of the present invention complete and to fully inform those skilled in the art of the scope of the invention. In the drawings, the same reference numerals refer to the same elements.

A method of manufacturing a lead tab for a secondary battery according to a preferred embodiment of the present invention may increase the bonding strength between an adhesive coating layer coated (applied) on the surface of the lead tab to attach a sealant film to the surface of the lead tab, and as a result, the state of stably adhering the sealant film to the lead tab may be maintained by improving the bonding strength between the lead tab and the sealant film. Here, the sealant film is interposed between the lead tab and a secondary battery cell pouch to tightly seal and prevent leakage of electrolyte, and also to be used for electrical insulation purpose.

Hereinafter, the present invention will be described in detail with reference to various embodiments.

In a method of manufacturing a lead tab for a secondary battery according to a first embodiment of the present invention, an adhesive is coated on one side (top surface) of the lead tab once, and the adhesive is coated on the other side (bottom surface) of the lead tab once.

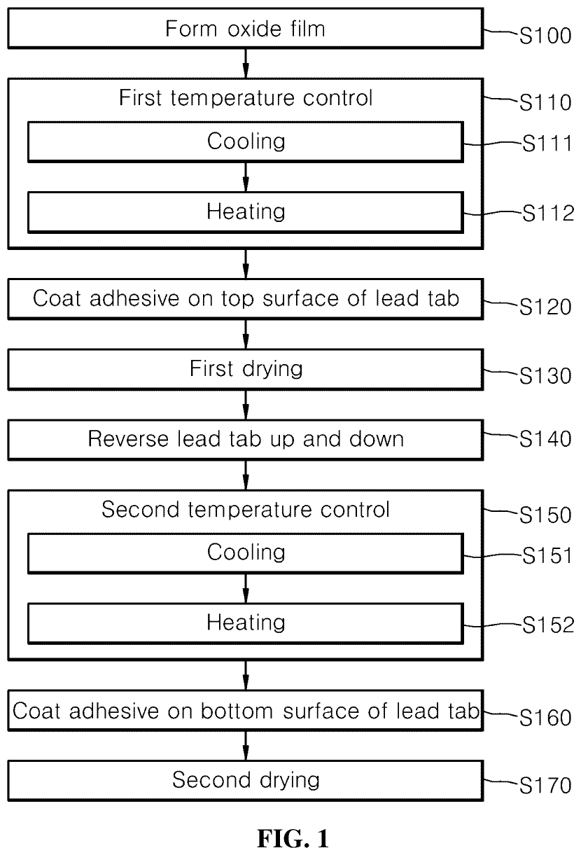

As shown in FIG. 1, the method of manufacturing a lead tab for a secondary battery according to a first embodiment of the present invention includes an oxide film formation step (S100), a first temperature control step (S110), a lead tab top surface adhesive coating step (S120), a first drying step (S130), a lead tab up and down reversing step (S140), a second temperature control step (S150), a lead tab bottom surface adhesive coating step (S160), and a second drying step (S170).

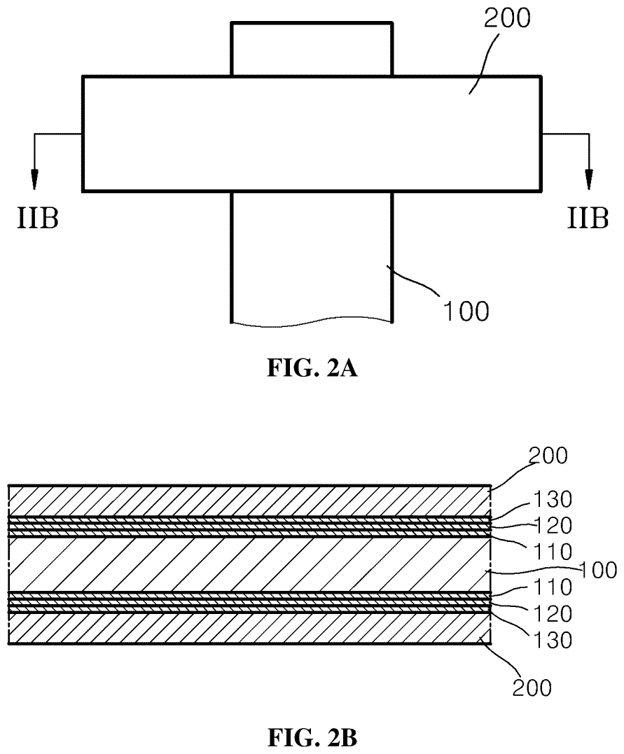

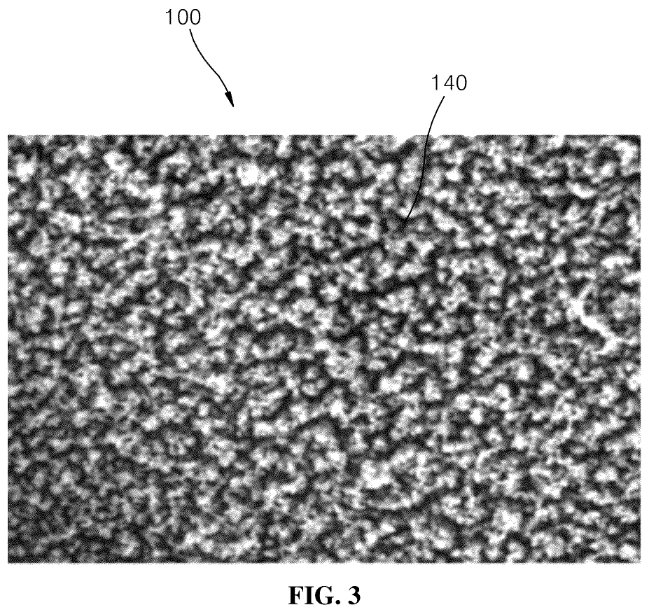

In the first embodiment of the present invention, prior to forming an oxide film, as shown in FIGS. 1 and 2, processing patterns 110 are formed on the top and bottom surfaces by radiating a laser beam on the processing areas set on the top and bottom surfaces of the lead tab 100.

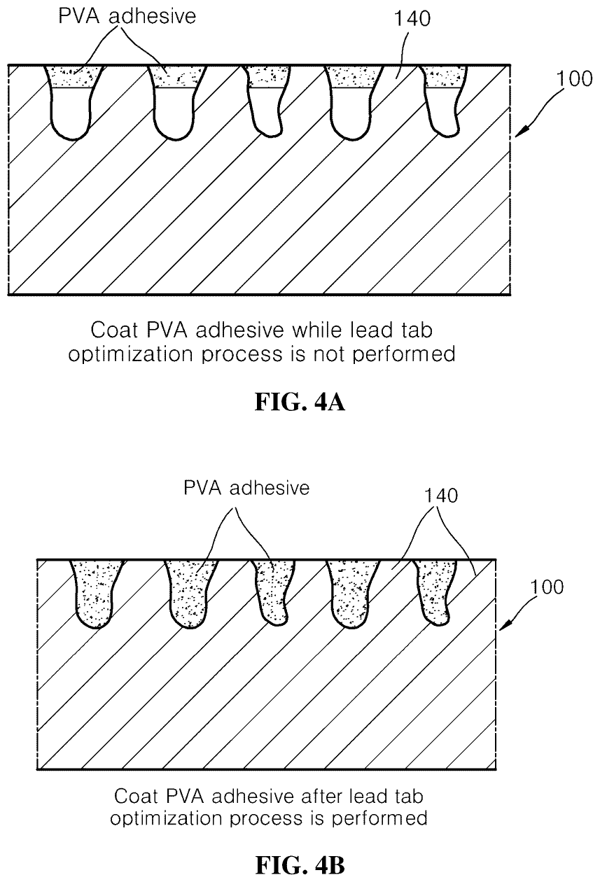

The lead tab 100 may be made of copper, an alloy of Ni—Cu, an AL material, or the like, and when the surface of the lead tab 100 is etched by radiating a laser beam on the surface, a protrusion structure with air gaps formed on the surface of the lead tab 100 is formed as shown in FIG. 3, and an adhesive such as PVA or the like described below is coated on the protrusion structure.

Hereinafter, describing the method of manufacturing a lead tab for a secondary battery according to a first embodiment of the present invention in order, first, heat of a predetermined temperature or higher is provided to the lead tab 100 having a processing pattern 110 formed on each of the top and bottom surfaces, and an oxide film 120 is formed on the surfaces on which the processing pattern is formed (S100).

Step S100 forms the oxide film 120 on the surface of a lead tab 100 configured of copper or a metal material made by plating nickel on the copper, specifically, on the surfaces on which a top surface processing pattern and a bottom surface processing pattern are formed.

Specifically, for example, at step S100, high temperature heat and hot air of approximately 300 to 350° C. may be applied to the surface of a lead tab made of a copper (nickel) material to form an oxide film 120 made of copper oxide (nickel oxide).

As the oxide film 120 stabilizes the surfaces of the lead tab, on which the top surface processing pattern and the bottom surface processing pattern are formed, and strengthens cross-linking with the PVA adhesive described below, a state of stably adhering the lead tab and the sealant film to each other may be maintained as a result.

Next, at the lead tab top surface adhesive coating step (S120) described below, the temperature of the lead tab 100 is adjusted in advance before the adhesive coating operation so that an adhesive solution may be coated on the surface of the lead tab 100, i.e., the oxide film 120 of the lead tab 100, in an optimized state (S110).

That is, step S110 is a process of optimizing the surface condition of the lead tab 100 in advance so that an adhesive may be coated (applied) on the surface of the lead tab 100 as effectively as possible through a process described below before the adhesive coating operation is performed on the surface of the lead tab 100.

Describing additionally, as shown in FIG. 2, effectively coating an adhesive on the surface of the lead tab 100 means forming an adhesive coating layer 130 on the oxide film 120 by stably coating the adhesive on the surface of the lead tab and increasing the bonding strength between the surface of the lead tab and the sealant film 200 as a result so that the sealant film may not be easily separated from the lead tab.

In an embodiment of the present invention, as shown in FIG. 1, step S110 may include a cooling step (S111) and a heating step (S112).

Specifically, the temperature of the lead tab 100 increased through step S100 is decreased to a first set temperature (S111) before step S112.

Here, step S111 is a stabilization process, i.e., a process of decreasing the temperature of the lead tab 100 increased in the oxide film formation process to the first set temperature, and as the time required for decreasing the temperature to a desired set temperature is shortened by artificial cooling rather than natural cooling, productivity in the manufacturing process is improved.

In an embodiment of the present invention, temperature of the lead tab may be decreased by arranging a temperature block having a first set temperature formed therein to directly contact the surface of the lead tab 100 on which a processing pattern is formed so that decrease in the temperature may be achieved by heat conduction or achieved by blowing a gas (air) having the first set temperature onto the surface on which the processing pattern is formed.

The first set temperature may be 30 to 50° C.

In addition, step S111 may maintain the initial starting temperature for increase in the temperature to be constant when the temperature increases at the heating step (S112) described below, so that when the lead tab is optimized before coating an adhesive while sequentially performing the cooling step (S111) and the heating step (S112) on the lead tab 100, all successively supplied lead tabs 100 may be uniformly optimized, and the coating quality and sealant film adhering quality may be maintained constant.

Hereinafter, the temperature of the lead tab 100 is increased to a second set temperature higher than the first set temperature (S112).

Here, step S112 is to increase the temperature of the lead tab 100 back to the second set temperature before coating the adhesive on the surface of the lead tab 100, and improve the bonding strength between the adhesive coating layer 130, which is coated through a process of coating an adhesive solution described below, and the lead tab 100. That is, an optimal temperature of the lead tab 100 is set and provided before coating the PVA adhesive so that the PVA adhesive can be efficiently adsorbed to the lead tab 100.

In an embodiment of the present invention, temperature of the lead tab may be increased by arranging a temperature block having a first set temperature formed therein to directly contact the surface of the lead tab 100 on which a processing pattern is formed so that increase in the temperature may be achieved by heat conduction or achieved by blowing a gas (air) having the second set temperature onto the surface on which the processing pattern is formed.

The second set temperature may be 90 to 170° C.

Next, as shown in FIGS. 1 and 2, the adhesive coating layer 130 is formed by coating the surface of the lead tab 100 on which a processing pattern and an oxide film are formed, specifically, by spraying an adhesive solution on the top surface of the lead tab 100 using a nozzle (S120).

Step S120 is a step of spraying a liquid adhesive as an adhesive on the surface of the oxide film 120 to attach the sealant film 200 to the top surface processing pattern portion of the lead tab 100, and the adhesive coating layer 130 is formed by applying a polyvinyl alcohol (PVA) adhesive solution on the surface of the lead tab 100 so that the sealant film may be easily adhered.

Here, the adhesive coating layer 130 may be coated as a polyvinyl alcohol adhesive solution obtained by mixing a mixed solution of polyvinyl alcohol resin and a hardener with deionized water at a predetermined weight ratio is applied on the surface of the lead tab.

An adhesive spray unit (not shown) may be provided to spray a liquid adhesive, i.e., a PVA adhesive solution, on the surface of the oxide film 120 formed on the top surface processing pattern and the bottom surface processing pattern of the lead tab 100.

The adhesive spray unit (not shown) includes a tank containing the PVA adhesive solution and a nozzle that receives the PVA adhesive solution from the tank and sprays it on the surface of the lead tab 100. The adhesive spray unit may further include a separate nozzle moving unit that may move the nozzle to approach or to be spaced apart from the surface of the lead tab.

FIG. 3 is an SEM image showing a protrusion structure formed on the surface of the lead tab 100 of a nickel material etched through laser radiation.

Observing the SEM image, it can be confirmed that a protrusion structure with pores is formed on the surface of the lead tab 100, and the reason why the PVA adhesive may be more stably coated on the surface of the lead tab as described above by heating the lead tab 100 at the second set temperature before coating the PVA adhesive is as described below.

When the temperature of the lead tab 100 is increased before PVA adhesive coating, the number of air particles arranged in the space between the surface protrusions of the lead tab 100 formed through laser etching is reduced, and at the moment when the PVA adhesive solution is sprayed and coated on the surface of the lead tab, coating is performed as the surface temperature of the lead tab is momentarily decreased and the PVA adhesive solution is quickly injected into the space between the surface protrusions of the lead tab.

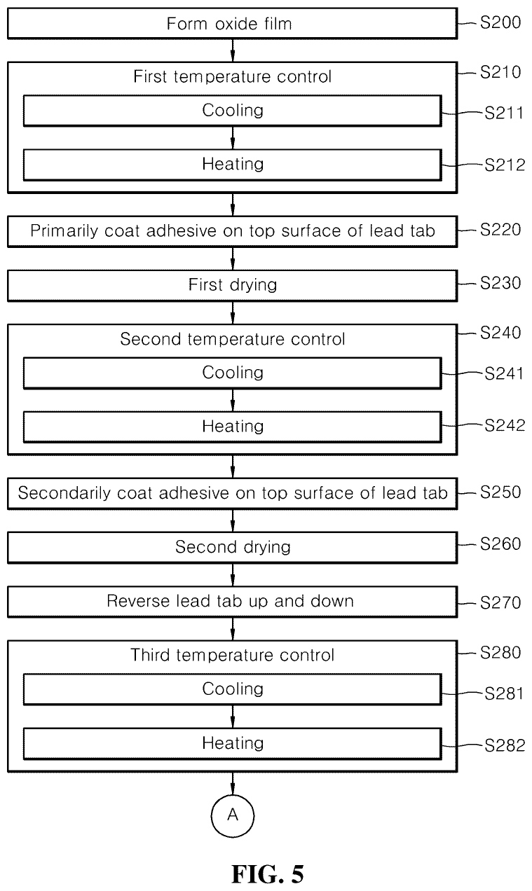

In addition, as shown in FIG. 4(b), a space having a predetermined depth or more from the outermost surface of the lead tab 100 is formed between the surface protrusions 140 of the lead tab 100, and the coating is performed while the PVA adhesive penetrates and completely fills to the deep bottom space between the surface protrusions of the lead tab, and as a result, the bonding strength between the PVA adhesive and the lead tab can be further increased.

The present invention may increase the bonding strength between the lead tab 100 and the PVA adhesive (adhesive coating layer 130) and furthermore the bonding strength between the sealant film 200 and the lead tab 100 by increasing the bonding strength between the PVA adhesive and the lead tab.

Next, as shown in FIG. 1, the adhesive solution remaining on the top surface of the lead tab 100 is dried and removed (S130).

As described above, coating is performed on the surface of the lead tab as the PVA adhesive solution is sprayed through a spray coating device while the temperature of the lead tab 100 is maintained at a high temperature such as the second set temperature (i.e., 90 to 170° C.), and some of the components included in the PVA adhesive solution may remain on the surface of the lead tab in a liquid state.

Step S130 is to prevent occurrence of defects such as decrease in the bonding strength when attaching the sealant film 200 by removing residual moisture in the PVA adhesive solution coated on the lead tab 100, and it may be applied by arranging a temperature block having a third set temperature formed therein to directly contact the surface of the lead tab 100 to allow heat transfer, or by blowing a gas (air) having the third set temperature onto the surface of the lead tab.

Here, the third set temperature may be 110 to 150° C.

In an embodiment of the present invention, step S130 may include a process of drying the surface of the lead tab 100 by radiating ultraviolet rays to remove the residual moisture in the PVA adhesive solution.

At step S130, the PVA adhesive solution may be cured and dried by radiating ultraviolet rays and blowing high-temperature hot air on the surface of the lead tab 100. Specifically, the PVA adhesive component in the liquid PVA adhesive solution may be cured by radiating ultraviolet rays, and moisture in the liquid PVA adhesive solution may be quickly dried by blowing hot air. Therefore, when step S130 is completed, only a cured PVA adhesive coating layer 130 may be formed on the oxide film surface on the top surface of the lead tab.

In an embodiment of the present invention, it is preferable that radiation of ultraviolet rays and blowing hot air are performed simultaneously, and accordingly, the process of curing and drying the PVA adhesive solution may be performed more quickly.

As described above, after the liquid PVA adhesive solution is sprayed on the oxide film formed on the top surface of the lead tab 100, and the PVA adhesive is cured and dried, the lead tab 100 is reversed up and down 180 degrees to repeat the same operation on the bottom surface of the lead tab 100 (S140).

Here, the lead tab 100 may be reversed up and down 180 degrees while being clamped by a lead tab reversing unit (not shown), and the lead tab reversing unit may include a gripper that clamps the lead tab and a rotation unit that may rotate the gripper 180 degrees or more.

Subsequently, as shown in FIG. 1, the temperature of the bottom surface of the lead tab 100 is adjusted in advance (S150) before the adhesive coating operation so that the adhesive solution may be coated on the surface of the lead tab 100 in an optimized state at the lead tab bottom surface adhesive coating step (S160) described below.

That is, step S150 is a process of optimizing the surface condition of the bottom surface of the lead tab 100 in advance so that the adhesive may be coated (applied) as effectively as possible on the bottom surface of the lead tab 100 before the adhesive coating operation is performed on the bottom surface of the lead tab 100, and may be applied in a manner the same as or similar to step S110.

In an embodiment of the present invention, as shown in FIG. 1, step S150 may include, for example, a cooling step (S151) and a heating step (S152) as described above.

Specifically, the temperature of the bottom surface of the lead tab 100 increased through step S100 is decreased to a first set temperature (S151) before step S152. The first set temperature may be 30 to 50° C.

Thereafter, the temperature of the bottom surface of the lead tab 100 is increased to a second set temperature higher than the first set temperature (S152). The second set temperature may be 90 to 170° C.

As the process of optimizing the surface condition of the bottom surface of the lead tab through the cooling and heating steps is the same as the process performed on the top surface of the lead tab as described above, repeated description thereof will be omitted.

Meanwhile, as another example, step S150 may also be performed to omit the cooling step (S151) and to perform only the heating step (S152).

Describing additionally, in order to remove the moisture in the PVA adhesive solution that may remain on the top surface of the lead tab 100, a high temperature of approximately 110 to 150° C. is applied to the top surface of the lead tab at step S130, and the high temperature may be transferred to the bottom surface of the lead tab 100 and increase the temperature of the bottom surface of the lead tab to a certain level or higher.

In addition, the temperature in the heating step (S152) may be 90 to 170° C. as described above, and as the cooling step (S151) that sets the temperature of the bottom surface of the lead tab 100 to approximately 30 to 50° C. is omitted, the energy and working time required to set the temperature of the bottom surface of the lead tab 100 to 90 to 170° C. while the lead tab 100 is reversed upside down may be further reduced, and therefore, product productivity can be increased.

Next, as shown in FIGS. 1 and 2, an adhesive solution is sprayed and coated on the surface of the lead tab 100, on which the processing pattern is formed, specifically, the bottom surface of the lead tab 100 (S160).

Next, as shown in FIG. 1, the adhesive solution remaining on the bottom surface of the lead tab 100 is dried and removed (S170).

Since steps S160 and S170 are performed in a manner substantially the same as steps S120 and S130 described above, duplicate description thereof will be omitted.

When some processes are completed in this manner, a sealant film 200 is attached on the top and bottom surfaces of the lead tab 100.

Hereinafter, a method of manufacturing a lead tab for a secondary battery according to a second embodiment of the present invention will be described, and description of the parts overlapped with the first embodiment will be omitted.

A method of manufacturing a lead tab for a secondary battery according to a second embodiment of the present invention is applying a case where an adhesive is coated twice on one side (top surface) of a lead tab and the adhesive is coated twice on the other side (bottom surface) of the lead tab, and this may be applied to supplement a case where it is difficult to sufficiently coat a PVA adhesive on the top and bottom surfaces of the lead tab with only one PVA adhesive solution coating operation.

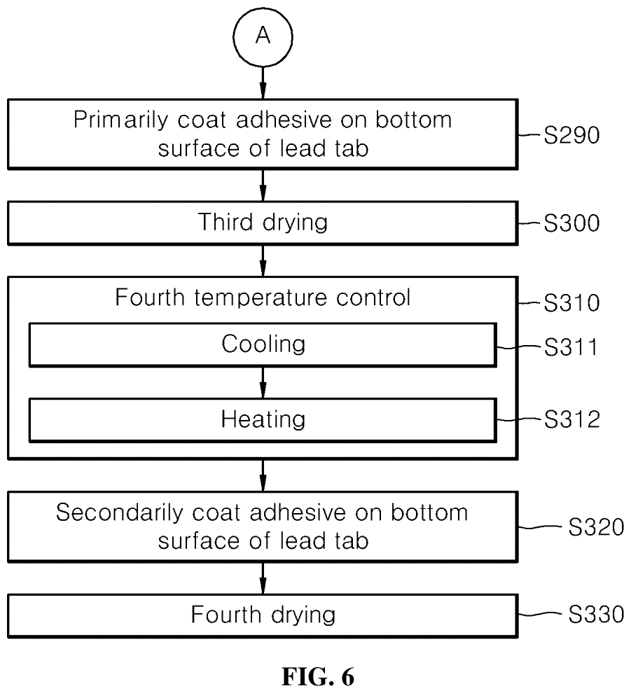

As shown in FIGS. 5 and 6, the method of manufacturing a lead tab for a secondary battery according to a second embodiment of the present invention includes an oxide film formation step (S200), a first temperature control step (S210), a lead tab top surface primary adhesive coating step (S220), a first drying step (S230), a second temperature control step (S240), a lead tab top surface secondary adhesive coating step (S250), a second drying step (S260), a lead tab up and down reversing step (S270), a third temperature control step (S280), a lead tab bottom surface primary adhesive coating step (S290), a third drying step (S300), a fourth temperature control step (S310), a lead tab bottom surface secondary adhesive coating step (S320), and a fourth drying step (S330).

The method of manufacturing a lead tab for a secondary battery according to a second embodiment of the present invention comprises a lead tab top surface primary adhesive coating step (S220), a lead tab top surface secondary adhesive coating step (S250), a lead tab bottom surface primary adhesive coating step (S290), and a lead tab bottom surface secondary adhesive coating step (S320) to coat a PVA adhesive solution twice on each of the top and bottom surfaces of the lead tab.

The first temperature control step (S210) is to optimize the surface condition of the top surface of the lead tab in advance before the primary coating operation so that the PVA adhesive may be primarily coated on the top surface of the lead tab as effectively as possible when performing the lead tab top surface primary adhesive coating step (S220), and the second temperature control step (S240) is to optimize the surface condition of the top surface of the lead tab in advance before the secondary coating operation so that the PVA adhesive may be secondarily coated on the top surface of the lead tab. In the same manner, the third temperature control step (S280) is to optimize the surface condition of the bottom surface of the lead tab in advance before the primary coating operation so that the PVA adhesive may be primarily coated on the bottom surface of the lead tab as effectively as possible when performing the lead tab bottom surface primary adhesive coating step (S290), and the fourth temperature control step (S310) is to optimize the surface condition of the bottom surface of the lead tab in advance before the secondary coating operation so that the PVA adhesive may be secondarily coated on the bottom surface of the lead tab.

The first drying step (S230) is a process of minimizing decrease in the efficiency of the PVA adhesive secondary coating operation by drying and removing the adhesive solution remaining on the top surface of the lead tab after primarily coating a PVA adhesive solution on the top surface of the lead tab and before performing the secondary coating operation, and the second drying step (S260) is to prevent occurrence of defects such as decrease in the bonding strength when attaching the sealant film by removing residual moisture on the top surface of the lead tab after the PVA adhesive solution is coated twice on the top surface of the lead tab.

The third drying step (S300) is a process corresponding to the first drying step (S230), and the fourth drying step (S330) is a process corresponding to the second drying step (S260). Although the application targets are different, such as the top and bottom surfaces of the lead tab, they are carried out in the same or similar manner overall.

In a second embodiment of the present invention, the first to fourth temperature control steps (S210, S240, S280, S310) may be configured to include both a cooling step and a heating step as mentioned in the first embodiment, and among them, the second to fourth temperature control steps (S240, S280, S310), excluding the first temperature control step (S210), may be configured to omit the cooling step and perform only the heating step. Since the description related thereto has already been described in the first embodiment, duplicate description thereof will be omitted.

Although the present invention has been illustrated and described with reference to preferred embodiments that exemplarily show the principles of the present invention, the present invention is not limited to the configuration and operation as is illustrated and described. Rather, it will be well understood by to those skilled in the art that a plurality of changes and modifications to the present invention can be made without departing from the spirit and scope of the appended claims.

According to the method of manufacturing a lead tab for a secondary battery of the present invention described above and the lead tab for a secondary battery manufactured according thereto, as a process of optimizing the surface condition of the lead tab is performed in advance so that an adhesive may be coated (applied) on the surface of the lead tab 100 as effectively as possible before the adhesive coating operation, the adhesive is stably coated on the surface of the lead tab, and the bonding strength between the surface of the lead tab and the sealant film is increased as a result, so that the sealant film may not be easily separated from the lead tab.

In addition, as the cross-linking with the PVA adhesive is strengthened by forming an oxide film by applying high temperature heat to the top surface processing pattern and bottom surface processing pattern areas, a state of stably adhering the lead tab and the sealant film to each other may be maintained.

### DESCRIPTION OF SYMBOLS

100: Lead tab 110: Processing pattern
120: Oxide film 130: Adhesive coating layer
140: Surface protrusions 200: Sealant film

What is claimed is:

1. A method of manufacturing a lead tab for a secondary battery, the method comprising the steps of:
(a) providing heat of a predetermined temperature or higher to the lead tab having a processing pattern formed on each of top and bottom surfaces to form an oxide film on the surfaces on which the processing pattern is formed; and
(c) coating the surfaces on which the oxide film is formed by spraying an adhesive solution, wherein
(b) a step of controlling a temperature of the lead tab is provided between steps (a) and (c) so that the adhesive solution may be coated on the surface of the lead tab in an optimized state at step (c).

2. The method according to claim 1, wherein step (b) includes a step of (b1) increasing the temperature of the lead tab to a second set temperature higher than a first set temperature.

3. The method according to claim 2, wherein step (b) further includes, before step (b1), a step of (b0) decreasing the temperature of the lead tab increased through step (a) to the first set temperature.

4. The method according to claim 1, wherein step (c) is a step of coating the upper surface of the lead tab by spraying an adhesive solution, wherein the method further comprises, after step (c), the step of (f) coating the bottom surface of the lead tab by spraying an adhesive solution, wherein the step of (e) controlling the temperature of the lead tab is provided between steps (c) and (f) so that the adhesive solution is coated on the bottom surface of the lead tab in an optimized state at step (f).

5. The method according to claim 4, further comprising the steps of:
(d1) drying and removing the adhesive solution remaining on the top surface of the lead tab, and
(d2) reversing the lead tab up and down, between steps (c) and (e); and
drying and removing the adhesive solution remaining on the bottom surface of the lead tab, after step (f).

6. The method according to claim 4, wherein step (e) includes:
the steps of decreasing the temperature of the lead tab increased through step (a) to a first set temperature, and increasing the temperature of the lead tab to a second set temperature higher than the first set temperature after decreasing the temperature to the first set temperature; or
the step of increasing the temperature of the lead tab to the second set temperature.

7. The method according to claim 6, wherein the step of decreasing the temperature of the lead tab to the first set temperature and the step of increasing the temperature of the lead tab to the second set temperature include the step of:
arranging a temperature block having a set temperature formed therein to directly contact the surface on which the processing pattern is formed; or
blowing a gas of the set temperature onto the surface on which the processing pattern is formed.

8. The method according to claim 5, wherein the step of drying and removing the adhesive solution remaining on the top surface and the bottom surface of the lead tab includes a step of drying by radiating an ultraviolet ray on the surface of the lead tab.

9. The method according to any one of claim 3, further comprising the steps of:
(g1) drying and removing the adhesive solution remaining on the surface of the lead tab after step (c); and
(g3) coating the surface of the lead tab by additionally spraying an adhesive solution after step (g1), wherein
the step of controlling the temperature of the lead tab is provided between steps (g1) and (g3) so that the adhesive solution is coated on the surface of the lead tab in an optimized state at step (g2).

10. The method according to claim 9, wherein step (g2) includes:
the steps of decreasing the temperature of the lead tab increased through step (a) to a first set temperature, and increasing the temperature of the lead tab to a second set temperature higher than the first set temperature after decreasing the temperature to the first set temperature; or
the step of increasing the temperature of the lead tab to the second set temperature.

11. A lead tab for a secondary battery manufactured through the method of manufacturing a lead tab for a secondary battery according to any one of claim 1.
